(19) United States
(12) Patent Application Publication
(10) Pub. No.: US 2026/0063575 A1
(43) Pub. Date: Mar. 5, 2026

(54) COMPUTED TOMOGRAPHY DEVICE WITH A HOLDING STRUCTURE FOR HOLDING A COMPONENT

(71) Applicant: Siemens Healthineers AG, Forchheim (DE)

(72) Inventors: Martin RAMSAUER, Pyrbaum (DE); Jens FEHRE, Hausen (DE); David DEDERICHS, Poxdorf (DE); Daniel KRIEGER, Pommersfelden (DE)

(73) Assignee: Siemens Healthineers AG, Forchheim (DE)

(21) Appl. No.: 19/314,842

(22) Filed: Aug. 29, 2025

(30) Foreign Application Priority Data
Aug. 30, 2024 (DE) 20 2024 104 954.3

(51) Int. Cl. G01N 23/046

(52) U.S. Cl. CPC G01N 23/046; G01N 2223/1016; G01N 2223/3035; G01N 2223/309; G01N 2223/419; G01N 2223/612

(57) ABSTRACT

The computed tomography device has a gantry with an opening, and a holding structure to hold a component relative to the opening. The holding structure has a component support surface that positively counteracts lowering of the component relative to the holding structure along a first connection axis once the component has been advanced from above along the first connection axis to establish a form-fit connection between the component and the component support surface. The holding structure also has an orientation structure that positively counteracts twisting of the component relative to the holding structure about the first connection axis once the component has been advanced from above along the first connection axis to establish a form-fit connection between the component and the component support surface.

### CROSS-REFERENCE TO RELATED APPLICATION(S)

The present application claims priority under 35 U.S.C. § 119 to German Patent Application No. 20 2024 104 954.3, filed Aug. 30, 2024, the entire contents of which is incorporated herein by reference.

### FIELD

One or more example embodiments of the present invention relate to a computed tomography device with a holding structure for holding a component.

### BACKGROUND

It may be necessary for a computed tomography examination to hold component relative to an opening of a gantry of a computed tomography device. Differently configured components may be considered for this purpose depending on the type of computed tomography examination.

### SUMMARY

At least one object of one or more example embodiments of the present invention is to provide a computed tomography device with a holding structure for holding a component relative to an opening of a gantry of the computed tomography device, in particular for use with differently configured components.

Each subject matter of an independent claim leads to the achievement of at least this object. The dependent claims address further advantageous aspects of one or more example embodiments of the present invention. Independent of the grammatical term usage, individuals with male, female or other gender identities are included within the term.

One or more example embodiments of the present invention relate to a computed tomography device having a gantry with an opening and a holding structure for holding a component relative to the opening,
wherein the holding structure has a component support surface such that the component support surface interlockingly (positively) counteracts lowering of the component relative to the holding structure along a first connection axis when the component is advanced from above along the first connection axis until the component is in interlocking connection with the component support surface on the holding structure,
wherein the holding structure has an orientation structure such that the orientation structure interlockingly (positively) counteracts twisting of the component relative to the holding structure about the first connection axis when the component is advanced from above along the first connection axis until the component is in interlocking (form-fit) connection with the component support surface on the holding structure.

Advancing the component from above along the first connection axis until the component is in interlocking (form-fit) connection with the component support surface on the holding structure can for example be carried out with one hand by an operator.

One embodiment provides that, in relation to the first connection axis, the orientation structure is located below the component support surface.

One embodiment provides that the holding structure has a hole for accommodating a pin of the component such that the pin is inserted into the hole along the first connection axis when the component is advanced from above along the first connection axis until the component is in interlocking (form-fit) connection with the component support surface on the holding structure, and that the component is secured against displacement, perpendicular to the first connection axis, relative to the holding structure by a displacement-blocking interlocking connection (also referred to as a displacement-blocking connection or a displacement-blocking form-fit connection) of the pin with an inner wall of the hole when the pin is inserted into the hole along the first connection axis.

One embodiment provides that the inner wall of the hole forms the orientation structure such that the component is secured against twisting of the component relative to the holding structure about the first connection axis by a twist-blocking interlocking connection (also referred to as a twist-blocking connection or a twist-blocking form-fit connection) of the pin with the inner wall of the hole when the pin is inserted into the hole along the first connection axis.

In particular, it can be provided that the inner wall of the hole has a planar first surface portion of the wall for the twist-blocking interlocking connection. It can furthermore be provided that the inner wall of the hole has a circular arc-shaped second surface portion of the wall and/or that the planar first surface portion of the wall adjoins the circular arc-shaped second surface portion of the wall in the manner of a chord, in particular to form a continuous contour of the inner wall of the hole. In particular, it can be provided that the planar first surface portion of the wall extends two-dimensionally parallel to the first connection axis.

In particular, it can be provided that the pin is cylindrical. For example, the pin can have a cylindrical shape that deviates from a circular-cylindrical shape and/or is prism-shaped. In particular, it can be provided that a circumferential surface of the pin has a planar first circumferential surface portion for the twist-blocking interlocking connection. It can furthermore be provided that the circumferential surface of the pin has a circular arc-shaped second circumferential surface portion and/or that the planar first circumferential surface portion adjoins the circular arc-shaped second circumferential surface portion in the manner of a chord, in particular to form a continuous contour of the circumferential surface of the pin. In particular, it can be provided that the planar first circumferential surface of the pin extends two-dimensionally parallel to the first connection axis and/or parallel to the planar first surface portion of the wall when the component is advanced from above along the first connection axis until the component is in interlocking (form-fit) connection with the component support surface on the holding structure.

In particular, it can be provided that, in relation to the first connection axis, the hole and/or the inner wall of the hole is located below the component support surface and/or that the component includes the pin. The holding structure can be made, for example, in one piece and/or of a metal alloy, in particular of aluminum and/or steel. The pin can be made, for example, in one piece and/or of a metal alloy, in particular of aluminum and/or steel.

The orientation structure and the component, in particular the hole and the pin, can in particular be configured mutually correspondingly such that they prevent advance of the component from above along the first connection axis until the component is in interlocking (form-fit) connection with the component support surface on the holding structure when a polar angle of the component relative to the orientation structure in relation to the first connection axis, in particular a polar angle of the pin relative to the hole in relation to the first connection axis, is outside a setpoint polar angular range.

One embodiment provides that the hole has a funnel-shaped entry region, wherein a wide end of the funnel-shaped entry region adjoins the component support surface, wherein a narrow end of the funnel-shaped entry region adjoins the inner wall of the hole. In this way, the pin of the component can be more simply inserted into the hole.

One embodiment provides that the holding structure has a sprung pressure piece, wherein the sprung pressure piece protrudes into the hole through a bore in the inner wall of the hole such that, on insertion of the pin into the hole along the first connection axis, the pin presses away a spring-mounted body of the sprung pressure piece against a spring force of the sprung pressure piece in a direction that is substantially perpendicular to the first connection axis, in particular before the interlocking (form-fit) connection of the component with the component support surface is achieved.

The spring-mounted body can, for example, be a sphere. Due to the additional force that has to be applied to come up against the spring force of the sprung pressure piece, physically perceptible feedback about the progress of insertion of the pin along the first connection axis into the hole of the holding structure is possible. The pin, in particular the planar first circumferential surface of the pin, can for example have a recess or a plurality of recesses for interlocked accommodation of the spring-mounted body of the sprung pressure piece.

One embodiment provides that the first connection axis is vertical. In particular, it can be provided that the component support surface is planar and/or horizontal. One embodiment provides that the opening extends in the manner of a tunnel along a system axis of the gantry such that the component can be inserted into the opening along the system axis when the component is advanced from above along the first connection axis until the component is in interlocking (form-fit) connection with the component support surface on the holding structure.

The system axis can for example be horizontal. In particular, it can be provided that the first connection axis is perpendicular to the system axis and/or that the planar first surface portion of the wall extends two-dimensionally perpendicular to the system axis.

One embodiment provides that the gantry has a first gantry part and a second gantry part,
wherein the first gantry part has a projection data acquisition system,
wherein the second gantry part has the holding structure,
wherein the first gantry part is mounted movably relative to the second gantry part such that a translational movement of the first gantry part relative to the second gantry part can be performed parallel to the system axis while the component is simultaneously stationary relative to the second gantry part, wherein the component is advanced from above along the first connection axis until the component is in interlocking (form-fit) connection with the component support surface on the holding structure.

In particular, it can be provided that the second gantry part has running gear, wherein the running gear is set up to move the gantry relative to a floor of a medical examination room and parallel to a translational direction, wherein the translational direction is horizontal and/or perpendicular to the system axis.

One embodiment provides that the computed tomography device includes the component. In particular, it can be provided that the component is advanced from above along the first connection axis until the component is in interlocking (form-fit) connection with the component support surface on the holding structure. In particular, it can be provided that the gantry has the holding structure.

One embodiment provides that the component has a head shell for holding a human head relative to the opening for an imaging examination of the head by way of the computed tomography device.

One embodiment provides that the component has an examination phantom for insertion into the opening for an imaging examination of the examination phantom by way of the computed tomography device.

One embodiment provides that the component has a positioning structure for positioning an object under examination for a pediatric computed tomography examination and has a support surface for the object under examination, wherein the support surface extends two-dimensionally along a longitudinal axis of the positioning structure, wherein the first connection axis is substantially perpendicular to the support surface. In particular, it can be provided that the longitudinal axis of the positioning structure is parallel to the system axis when the component is advanced from above along the first connection axis until the component is in interlocking (form-fit) connection with the component support surface on the holding structure.

The object under examination can in particular be a human. The object under examination can for example be a baby or infant. The object under examination can for example be positioned recumbent and/or relative to a gantry of a computed tomography device. The computed tomography device can in particular be configured as a head computed tomography device for the head of an adult human and/or as a mobile computed tomography device.

One embodiment provides that the computed tomography device has a body support apparatus for supporting a human body relative to the opening,
wherein the body support apparatus has a board, a swivel bearing bushing and a swivel bearing pin,
wherein the swivel bearing bushing has a swivel bearing base, wherein the swivel bearing base extends lengthwise along a swivel axis of the swivel bearing bushing,
wherein the swivel bearing base has a slot that extends parallel to the swivel axis such that the swivel bearing pin can be inserted into the slot in an insertion direction that is perpendicular to the swivel axis and perpendicular to a longitudinal direction of the swivel bearing pin, in particular until the swivel bearing pin is arranged substantially coaxially with the swivel axis,
wherein the swivel bearing bushing has at least one swivel bearing cover, wherein the swivel bearing pin is secured by an interlocking (form-fit) connection of the swivel bearing pin with the at least one swivel bearing cover against displacement relative to the swivel axis in a direction that is opposed to the insertion direction when the swivel bearing pin is arranged substantially coaxially with the swivel axis and the at least one swivel bearing cover is connected to the swivel bearing base,
wherein the board can be mounted such that it can swivel relative to the gantry about the swivel axis by way of the swivel bearing bushing and the swivel bearing pin such that the board can be lowered relative to the gantry from a preparation position of the board to an examination position of the board by a first swivel movement of the board about the swivel axis.

One or more example embodiments of the present invention further relate to a computed tomography device having a gantry with an opening and a body support apparatus for supporting a human body relative to the opening,
wherein the body support apparatus has a board, a swivel bearing bushing and a swivel bearing pin,
wherein the swivel bearing bushing has a swivel bearing base, wherein the swivel bearing base extends lengthwise along a swivel axis of the swivel bearing bushing,
wherein the swivel bearing base has a slot that extends parallel to the swivel axis such that the swivel bearing pin can be inserted into the slot in an insertion direction that is perpendicular to the swivel axis and perpendicular to a longitudinal direction of the swivel bearing pin, in particular until the swivel bearing pin is arranged substantially coaxially with the swivel axis,
wherein the swivel bearing bushing has at least one swivel bearing cover, wherein the swivel bearing pin is secured by an interlocking (form-fit) connection of the swivel bearing pin with the at least one swivel bearing cover against displacement relative to the swivel axis in a direction that is opposed to the insertion direction when the swivel bearing pin is arranged substantially coaxially with the swivel axis and the at least one swivel bearing cover is connected to the swivel bearing base,
wherein the board can be mounted such that it can swivel relative to the gantry about the swivel axis by way of the swivel bearing bushing and the swivel bearing pin such that the board can be lowered relative to the gantry from a preparation position of the board to an examination position of the board by a first swivel movement of the board about the swivel axis.

The swivel axis can for example be horizontal. The swivel axis can for example be perpendicular to the first connection axis and/or perpendicular to the system axis. In particular, it can be provided that the holding structure includes the swivel bearing bushing. In particular, it can be provided that the planar first surface portion of the wall extends two-dimensionally parallel to the swivel axis.

In particular, the body support apparatus can be arranged relative to the opening such that a shoulder region of the human's body is lying on the board when the board is in the examination position of the board relative to the gantry and the human's head is inserted into the opening along a system axis of the gantry. The computed tomography device can in particular be configured as a head computed tomography device and/or as a mobile computed tomography device. In particular, it can be provided that the human can be moved along the system axis of the gantry relative to the gantry, in particular can be carried by medical personnel, in order thereby to insert the human's head into the opening when the board is in the examination position of the board.

In particular, it can be provided that the board extends two-dimensionally in a board plane and/or that the board plane is substantially parallel, in particular parallel, to the swivel axis. In particular, it can be provided that the board plane is substantially perpendicular, in particular perpendicular, to the system axis when the board is in the preparation position of the board. In particular, it can be provided that the board protrudes away from the opening when the board is in the examination position of the board. In particular, it can be provided that an angle between the board plane and the system axis is less than 45 degrees, for example less than 20 degrees, in particular less than 10 degrees, when the board is in the examination position of the board.

One embodiment provides that the swivel bearing base has a groove that extends parallel to the swivel axis such that the at least one swivel bearing cover can be inserted into the slot in a direction parallel to the swivel axis, wherein a rib of the at least one swivel bearing cover can be inserted into the groove in the direction parallel to the swivel axis such that the at least one swivel bearing cover is secured by an interlocking (form-fit) connection of the rib with the groove against displacement relative to the swivel axis in the insertion direction and/or in the direction that is opposed to the insertion direction.

One or more other example embodiments of the present invention provide a computed tomography device, including: a gantry with an opening; and a holding structure configured to hold a component relative to the opening, the holding structure including a component support surface that positively counteracts lowering of the component relative to the holding structure along a first connection axis once the component has been advanced from above along the first connection axis to establish a form-fit connection between the component and the component support surface, and an orientation structure that positively counteracts twisting of the component relative to the holding structure about the first connection axis once the component has been advanced from above along the first connection axis to establish a form-fit connection between the component and the component support surface.

At least one example embodiment provides a computed tomography device, wherein the holding structure has a hole to accommodate a pin of the component such that the pin is inserted into the hole along the first connection axis once the component has been advanced from above along the first connection axis to establish a form-fit connection between the component and the component support surface, and the component is secured against displacement, perpendicular to the first connection axis, relative to the holding structure by a displacement-blocking connection of the pin with an inner wall of the hole once the pin is inserted into the hole along the first connection axis.

At least one example embodiment provides a computed tomography device, wherein the inner wall of the hole forms the orientation structure such that the component is secured against twisting of the component relative to the holding structure about the first connection axis by a twist-blocking connection of the pin with the inner wall of the hole once the pin is inserted into the hole along the first connection axis.

At least one example embodiment provides a computed tomography device, wherein the hole has a funnel-shaped entry region, a wide end of the funnel-shaped entry region adjoins the component support surface, and a narrow end of the funnel-shaped entry region adjoins the inner wall of the hole.

At least one example embodiment provides a computed tomography device, wherein the holding structure has a spring pressure piece, and the spring pressure piece protrudes into the hole through a bore in the inner wall of the hole such that, on insertion of the pin into the hole along the first connection axis, the pin presses away a spring-mounted body of the spring pressure piece against a spring force of the spring pressure piece in a direction that is substantially perpendicular to the first connection axis.

At least one example embodiment provides a computed tomography device, wherein the opening extends in a tunnel manner along a system axis of the gantry such that the component is inserted into the opening along the system axis once the component is advanced from above along the first connection axis to establish the form-fit connection between the component and the component support surface.

At least one example embodiment provides a computed tomography device, including: a gantry with an opening; and a body support apparatus configured to support a human body relative to the opening, the body support apparatus including a board, a pivot bearing bushing and a pivot bearing pin, wherein the pivot bearing bushing has a pivot bearing base, the pivot bearing base extends lengthwise along a pivot axis of the pivot bearing bushing, wherein the pivot bearing base has a slot that extends parallel to the pivot axis such that the pivot bearing pin is insertable into the slot in an insertion direction that is perpendicular to the pivot axis and perpendicular to a longitudinal direction of the pivot bearing pin, wherein the pivot bearing bushing has at least one pivot bearing cover, wherein the pivot bearing pin is secured, by a form-fit connection between the pivot bearing pin and the at least one pivot bearing cover, against displacement relative to the pivot axis in a direction that is opposed to the insertion direction when the pivot bearing pin is arranged substantially coaxially with the pivot axis and the at least one pivot bearing cover is connected to the pivot bearing base, and wherein the board is configured to be mounted such that the board pivots relative to the gantry about the pivot axis by way of the pivot bearing bushing and the pivot bearing pin such that the board is lowerable relative to the gantry from a preparation position of the board to an examination position of the board by a first pivot movement of the board about the pivot axis.

At least one example embodiment provides a computed tomography device, wherein the pivot bearing base has a groove that extends parallel to the pivot axis such that the at least one pivot bearing cover is insertable into the slot in a direction parallel to the pivot axis, and a rib of the at least one pivot bearing cover is insertable into the groove in the direction parallel to the pivot axis such that the at least one pivot bearing cover is secured against displacement relative to the pivot axis in at least one of the insertion direction or a direction that is opposed to the insertion direction by a form-fit connection between the rib and the groove.

At least one example embodiment provides a computed tomography device, wherein the pin presses away the spring-mounted body of the spring pressure piece against the spring force of the spring pressure piece in the direction that is substantially perpendicular to the first connection axis before achieving the form-fit connection between the component and the component support surface.

At least one example embodiment provides a computed tomography device, wherein the pivot bearing pin is insertable into the slot in the insertion direction that is perpendicular to the pivot axis and perpendicular to the longitudinal direction of the pivot bearing pin until the pivot bearing pin is arranged substantially coaxially with the pivot axis.

At least one example embodiment provides a computed tomography device, wherein the holding structure has a spring pressure piece, and the spring pressure piece protrudes into the hole through a bore in the inner wall of the hole such that, on insertion of the pin into the hole along the first connection axis, the pin presses away a spring-mounted body of the spring pressure piece against a spring force of the spring pressure piece in a direction that is substantially perpendicular to the first connection axis.

At least one example embodiment provides a computed tomography device, wherein the opening extends in a tunnel manner along a system axis of the gantry such that the component is inserted into the opening along the system axis once the component is advanced from above along the first connection axis to establish the form-fit connection between the component and the component support surface.

For the purposes of the present invention, features that are described in relation to different embodiments of the present invention and/or different claim categories (method, use, device, system, arrangement etc.) may be combined to yield further embodiments of the present invention. For example, a claim relating to an apparatus may also be further developed with features which are described or claimed in connection with a method and vice versa. Functional features of a method may in this case be embodied by appropriately configured physical components. Use of the indefinite article “a” or “an” does not rule out the possibility of the feature in question also being present in multiple instances.

### BRIEF DESCRIPTION OF THE DRAWINGS

Features of the present invention are explained below with reference to examples and to the appended figures. The depictions in the figures are schematic, highly simplified and not necessarily true to scale.

FIG. 1 shows a mobile computed tomography device with a head shell.

FIG. 2 and FIG. 3 show a body support apparatus.

FIG. 4 and FIG. 5 show different views of a holding structure.

FIG. 6 shows a lever mechanism.

FIG. 7 shows a phantom holder.

FIG. 8 shows an examination phantom.

FIG. 9 shows a mobile computed tomography device with a positioning structure for positioning an object under examination for a pediatric computed tomography examination.

FIG. 10 shows a computed tomography device with an examination table.

### DETAILED DESCRIPTION

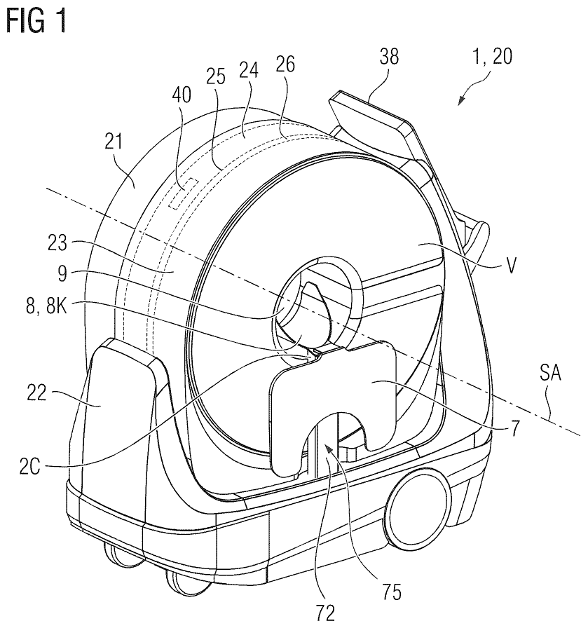

FIG. 1 shows the computed tomography device 1 in the form of a mobile computed tomography device with the head shell 8K,
wherein the computed tomography device 1 has a gantry 20 with an opening 9 and a holding structure 2C for holding a component 8 relative to the opening 9,
wherein the holding structure 2C has a component support surface 2CY such that the component support surface 2CY interlockingly (positively) counteracts lowering of the component 8 relative to the holding structure 2C along a first connection axis CA1 when (once) the component 8 is (has been) advanced from above along the first connection axis CAL and a form-fit connection between the component 8 and the component support surface 2CY on the holding structure 2C is established,
wherein the holding structure 2C has an orientation structure 2CZ such that the orientation structure 2CZ positively counteracts twisting of the component 8 relative to the holding structure 2C about the first connection axis CA1 when (once) the component 8 is (has been) advanced from above along the first connection axis CAL and the component 8 a form-fit connection with the component support surface 2CY on the holding structure 2C is established.

The first gantry part 21 has the rotary mount 25 and the load-bearing structure 26, wherein the rotor 24 is connected to the load-bearing structure 26 by way of the rotary mount 25 and is rotatably mounted relative to the load-bearing structure 26 about the system axis SA. The rotor 24 has the projection data acquisition system 40. The projection data acquisition system 40 has an X-ray source for generating X-rays and an X-ray detector for detecting the X-rays.

The second gantry part 22 has the holding structure 2C, the body support apparatus 75 with the board 7 and the touch-sensitive screen 38 for operating the computed tomography device 1. The board 7 is mounted such that it can swivel or pivot relative to the gantry 20 about the swivel axis 7A (also referred to as a pivot axis 7A) by way of the swivel bearing bushing 7B (also referred to as a pivot bearing bushing 7B) and the swivel bearing pin 7L (also referred to as a pivot bearing pin 7L), wherein the swivel axis 7A is horizontal and perpendicular to the system axis SA. The second gantry part 22 has the holding device 72 for the holding structure 2C.

The gantry 20 has the cladding V for delimiting an internal region of the gantry 20 from the surroundings of the gantry 20. The gantry 20 has the third gantry part 23. The third gantry part 23 has a front face of the cladding V. The front face of the cladding V annularly surrounds a front face of the opening 9. The first gantry part 21 has a back face of the cladding V. The back face of the cladding V annularly surrounds a back face of the opening 9.

The first gantry part 21 is movably mounted relative to the second gantry part 22 and relative to the third gantry part 23 such that the translational movement of the first gantry part 21 relative to the second gantry part 22 and the third gantry part 23 can be performed while the second gantry part 22 and the third gantry part 23 are simultaneously stationary relative to the component 8, wherein the component 8 is inserted into the opening 9.

The example shown provides that the gantry 20 has a first gantry part 21 and a second gantry part 22,
wherein the first gantry part 21 has a projection data acquisition system 40,
wherein the second gantry part 22 has the holding structure 2C,
wherein the first gantry part 21 is mounted movably relative to the second gantry part 22 such that a translational movement of the first gantry part 21 relative to the second gantry part 22 can be performed parallel to the system axis SA while the component 8 is simultaneously stationary relative to the second gantry part 22, wherein the component 8 is advanced from above along the first connection axis CA1 until the component 8 is in interlocking connection with the component support surface 2CY on the holding structure 2C.

In particular, it can be provided that the second gantry part 22 has running gear, wherein the running gear is set up to move the gantry 20 relative to a floor of a medical examination room and parallel to a translational direction, wherein the translational direction is horizontal and/or perpendicular to the system axis SA.

The example shown provides that the computed tomography device 1 includes the component 8.

In particular, it can be provided that the component 8 is advanced from above along the first connection axis CA1 until the component 8 is in interlocking connection with the component support surface 2CY on the holding structure 2C. In particular, it can be provided that the gantry has the holding structure.

The example shown in FIG. 1 provides that the component 8 has a head shell 8K for holding a human head relative to the opening 9 for an imaging examination of the head by way of the computed tomography device 1.

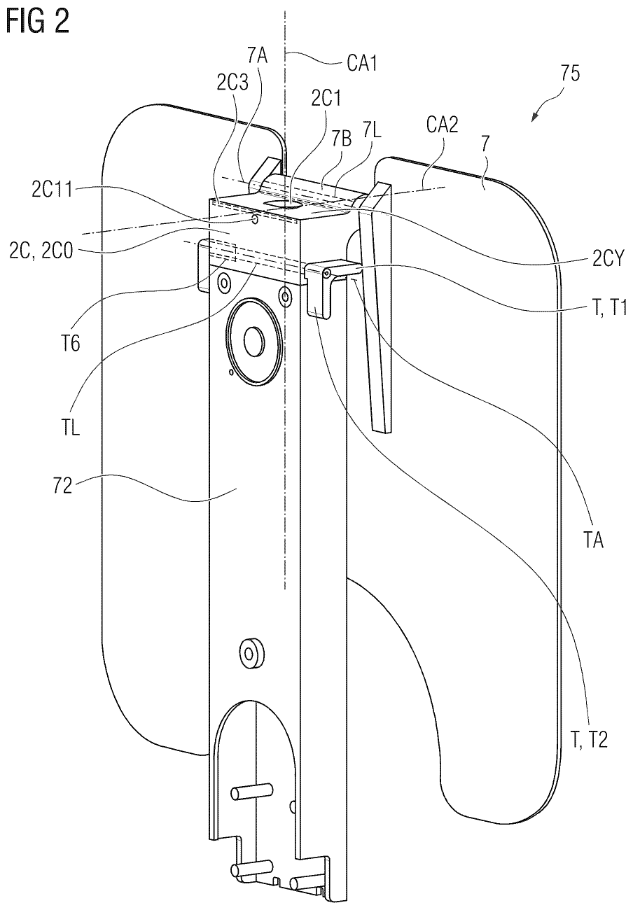

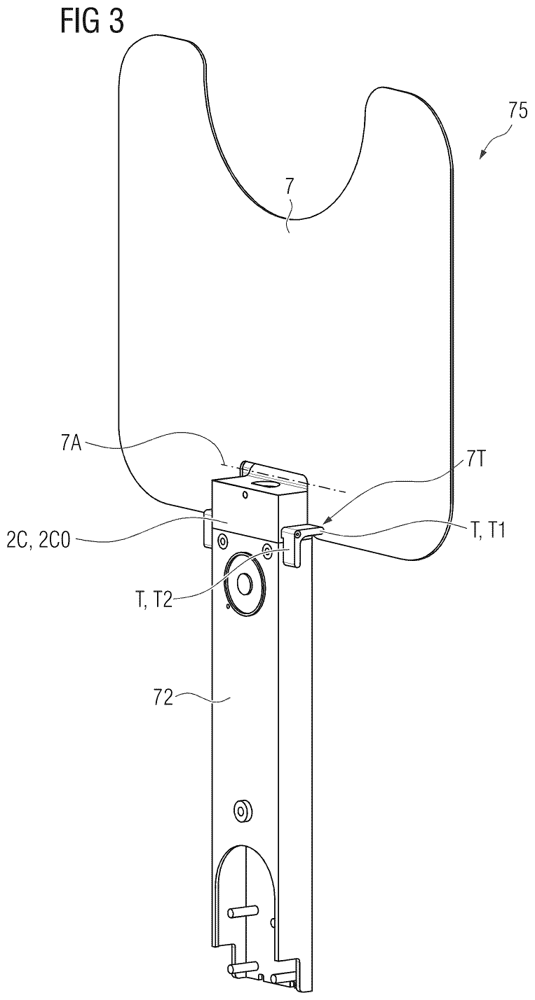

FIG. 2 shows the body support apparatus 75 with the board 7 in a transport position of the board 7. FIG. 3 shows the body support apparatus 75 with the board 7 in a preparation position of the board 7.

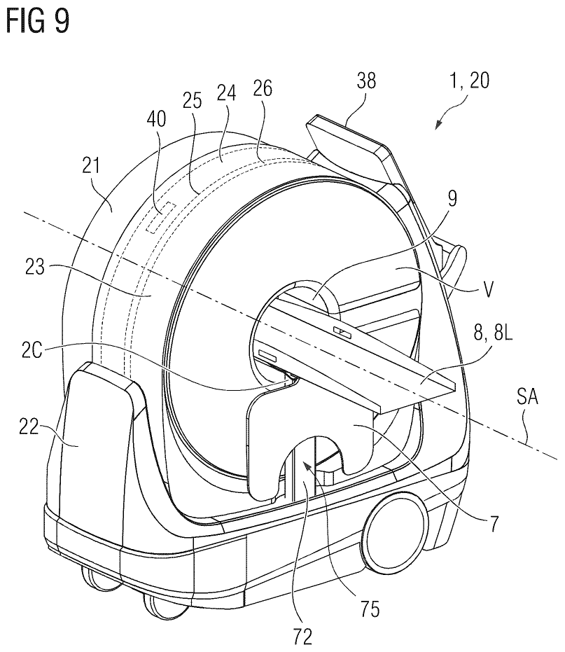

The example shown in FIG. 1 and the example shown in FIG. 9 each provide that the computed tomography device 1 has the gantry 20 with the opening 9 and the body support apparatus 75 for supporting a human body relative to the opening 9,
wherein the body support apparatus 75 has a board 7, a swivel bearing bushing 7B and a swivel bearing pin 7L,
wherein the swivel bearing bushing 7B has a swivel bearing base 7B1, wherein the swivel bearing base 7B1 (also referred to as a pivot bearing base 7B1) extends lengthwise along a swivel axis 7A of the swivel bearing bushing 7B,
wherein the swivel bearing base 7B1 has a slot that extends parallel to the swivel axis 7A such that the swivel bearing pin 7L can be inserted into the slot in an insertion direction that is perpendicular to the swivel axis 7A and perpendicular to a longitudinal direction of the swivel bearing pin 7L, in particular until the swivel bearing pin 7L is arranged substantially coaxially with the swivel axis 7A,
wherein the swivel bearing bushing 7B has at least one swivel bearing cover 7B2, wherein the swivel bearing pin 7L is secured by an interlocking connection of the swivel bearing pin 7L with the at least one swivel bearing cover 7B2 against displacement relative to the swivel axis 7A in a direction that is opposed to the insertion direction when the swivel bearing pin 7L is arranged substantially coaxially with the swivel axis 7A and the at least one swivel bearing cover 7B2 is connected to the swivel bearing base 7B1,
wherein the board 7 can be mounted such that it can swivel relative to the gantry 20 about the swivel axis 7A by way of the swivel bearing bushing 7B and the swivel bearing pin 7L such that the board 7 can be lowered relative to the gantry 20 from a preparation position of the board 7 to an examination position of the board 7 by a first swivel movement of the board 7 about the swivel axis 7A.

The swivel axis 7A can for example be horizontal. The swivel axis 7A can for example be perpendicular to the first connection axis CA1 and/or perpendicular to the system axis SA. In particular, it can be provided that the holding structure 2C includes the swivel bearing bushing 7B. In particular, it can be provided that the planar first surface portion of the wall extends two-dimensionally parallel to the swivel axis 7A.

The body support apparatus 75 includes the lever mechanism T that is set up to interlockingly (positively) secure the board 7 against lowering when the board 7 is in the preparation position of the board 7. The lever mechanism T has a first lever arm T1 and a second lever arm T2 and is mounted such that it can swivel about a lever axis TA that is parallel to the swivel axis 7A. The first lever arm T1 and the second lever arm T2 are rigidly connected together in the region of the lever axis TA.

In the operating state of the body support apparatus 75, which is shown in FIG. 3, the lever mechanism T interlockingly (positively) secures the board 7 against lowering by the first lever arm T1 barring the path for the peripheral region 7T of the board 7 that the peripheral region 7T of the board 7 requires for the first swivel movement of the board 7 about the swivel axis 7A. The first lever arm T1 is lowered relative to the peripheral region 7T of the board 7 by manually pushing the second lever arm T2 away from the board 7 against the spring force of the torsion spring T6. In this way, the path that the peripheral region 7T of the board 7 requires for the first swivel movement of the board 7 about the swivel axis 7A can be opened up such that the board 7 can be lowered relative to the gantry 20 from a preparation position of the board 7 to an examination position of the board 7 by the first swivel movement of the board 7 about the swivel axis 7A.

In particular, it can be provided that, during the preparative swivel movement of the board 7 about the swivel axis 7A and/or during the further swivel movement of the board 7 about the swivel axis 7A, the peripheral region 7T of the board 7 presses the first lever arm T1 away, for example downward, and thus itself clears the path that the peripheral region 7T of the board 7 requires for the preparative swivel movement of the board 7 about the swivel axis 7A and/or for the further swivel movement of the board 7 about the swivel axis 7A. In particular, it can be provided that, as soon as the board 7 has reached the preparation position of the board 7, the lever mechanism T swivels back into the resting position shown in FIG. 3, for example driven by a torsion spring T6 of the lever mechanism T. The torsion spring T6 of the lever mechanism T can in particular be arranged coaxially with the lever axis TA.

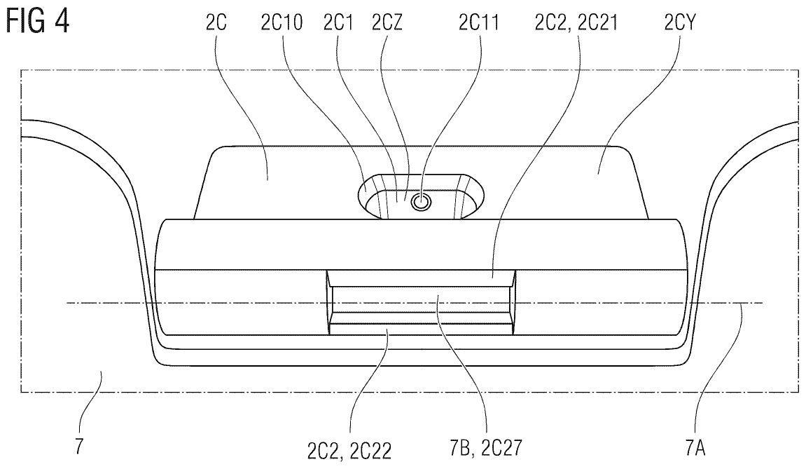

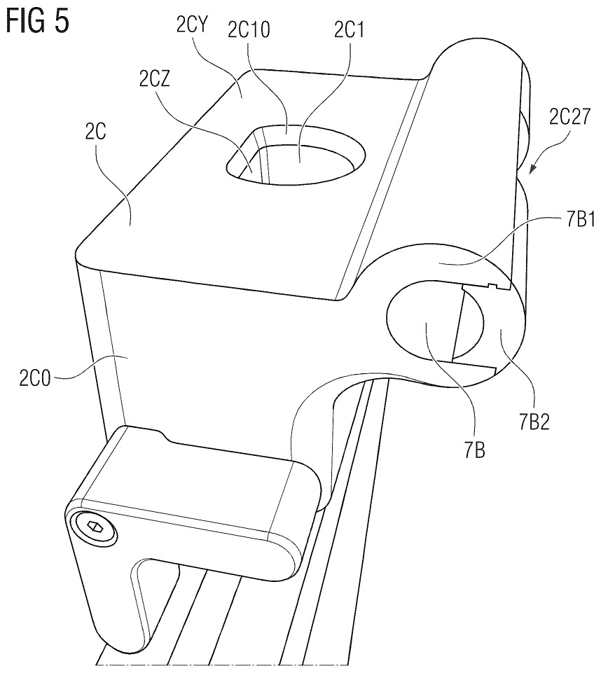

FIG. 4 and FIG. 5 show different views of the holding structure 2C. The example shown provides that, in relation to the first connection axis CA1, the orientation structure 2CZ is below the component support surface 2CY.

The example shown provides that the holding structure 2C has a hole 2C1 for accommodating a pin C1 of the component 8 such that the pin C1 is inserted into the hole 201 along the first connection axis CA1 when the component 8 is advanced from above along the first connection axis CA1 until the component 8 is in interlocking connection with the component support surface 2CY on the holding structure 2C, and that the component 8 is secured against displacement, perpendicular to the first connection axis CA1, relative to the holding structure 2C by a displacement-blocking interlocking connection of the pin C1 with an inner wall of the hole 2C1 when the pin C1 is inserted into the hole 201 along the first connection axis CA1.

The example shown provides that the inner wall of the hole 2C1 forms the orientation structure 2CZ such that the component 8 is secured against twisting of the component 8 relative to the holding structure 2C about the first connection axis CA1 by a twist-blocking interlocking connection of the pin C1 with the inner wall of the hole 2C1 when the pin C1 is inserted into the hole 201 along the first connection axis CA1.

In particular, it can be provided that the inner wall of the hole 2C1 has a planar first surface portion of the wall for the twist-blocking interlocking connection. It can furthermore be provided that the inner wall of the hole 2C1 has a circular arc-shaped second surface portion of the wall and/or that the planar first surface portion of the wall adjoins the circular arc-shaped second surface portion of the wall in the manner of a chord, in particular to form a continuous contour of the inner wall of the hole 2C1. In particular, it can be provided that the planar first surface portion of the wall extends two-dimensionally parallel to the first connection axis CA1.

The example shown provides that the hole 2C1 has a funnel-shaped entry region 2010, wherein a wide end of the funnel-shaped entry region 2010 adjoins the component support surface 2CY, wherein a narrow end of the funnel-shaped entry region 2010 adjoins the inner wall of the hole 2C1.

The example shown in FIG. 5 provides that the swivel bearing base 7B1 has a groove that extends parallel to the swivel axis 7A such that the at least one swivel bearing cover 7B2 can be inserted into the slot in a direction parallel to the swivel axis 7A, wherein a rib of the at least one swivel bearing cover 7B2 can be inserted into the groove in the direction parallel to the swivel axis 7A such that the at least one swivel bearing cover 7B2 is secured by an interlocking connection of the rib with the groove against displacement relative to the swivel axis 7A in the insertion direction and/or in the direction that is opposed to the insertion direction.

The example shown provides that the holding structure 2C has a sprung pressure piece 2C11, wherein the sprung pressure piece 2C11 protrudes into the hole 2C1 through a bore in the inner wall of the hole 2C1 such that, on insertion of the pin C1 into the hole 201 along the first connection axis CA1, the pin C1 presses away a spring-mounted body of the sprung pressure piece 2C11 against a spring force of the sprung pressure piece 2C11 in a direction that is substantially perpendicular to the first connection axis CA1, in particular before the interlocking connection of the component 8 with the component support surface 2CY is achieved.

The example shown provides that the first connection axis CA1 is vertical.

In particular, it can be provided that the component support surface 2CY is planar and/or horizontal.

The example shown provides that the opening 9 extends in the manner of a tunnel along a system axis SA of the gantry 20 such that the component 8 can be inserted into the opening 9 along the system axis SA when the component 8 is advanced from above along the first connection axis CAL until the component 8 is in interlocking connection with the component support surface 2CY on the holding structure 2C.

The system axis SA can for example be horizontal. In particular, it can be provided that the first connection axis CA1 is perpendicular to the system axis SA and/or that the planar first surface portion of the wall extends two-dimensionally perpendicular to the system axis SA.

One end of the groove can interlockingly (positively) prevent further insertion of the at least one swivel bearing cover 7B2 such that the gap 2C27 remains open as part of the slot.

The holding structure 2C has a clamping jaw-side contact surface 2C2 of the holding structure 2C for two-dimensional contact with a clamping jaw, wherein the clamping jaw-side contact surface 2C2 of the holding structure 2C extends two-dimensionally perpendicular to the second connection axis CA2, wherein the clamping jaw-side contact surface 2C2 of the holding structure 2C has a first surface portion 2C21 and a second surface portion 2C22. The holding structure 2C has a counterpart-side contact surface 2C3 of the holding structure 2C for two-dimensional contact with a counterpart to the clamping jaw such that the holding structure 2C can be clamped between the clamping jaw and the counterpart.

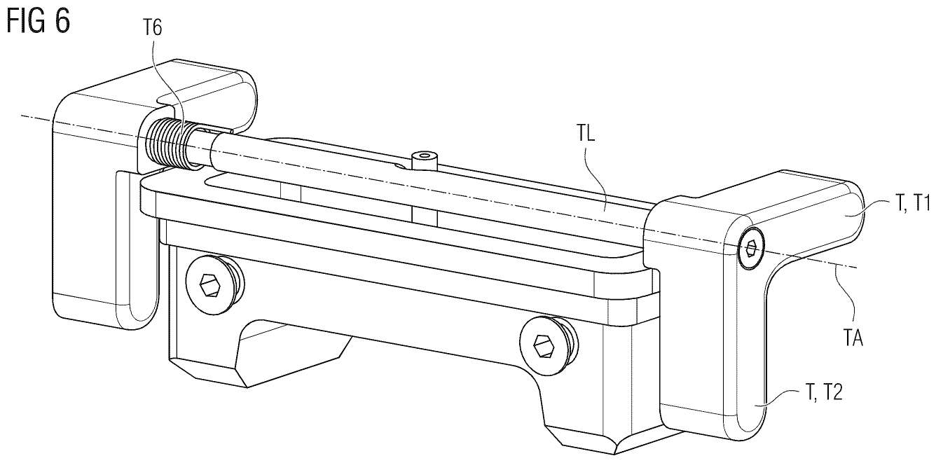

FIG. 6 shows the lever mechanism T. The lever mechanism T can be configured in particular substantially symmetrically in relation to a vertical plane that contains the system axis SA. For example, the lever mechanism T can have a third lever arm arranged symmetrically to the first lever arm T1 and a fourth lever arm arranged symmetrically to the second lever arm T2. In particular, it can be provided that, in relation to the lever axis TA, the holding structure 2C is located between the first lever arm T1 and the third lever arm and/or between the second lever arm T2 and the fourth lever arm and/or that the lever bearing pin TL of the lever mechanism T extends coaxially with the lever swivel axis TA through corresponding bores in the housing 200 of the holding structure 2C.

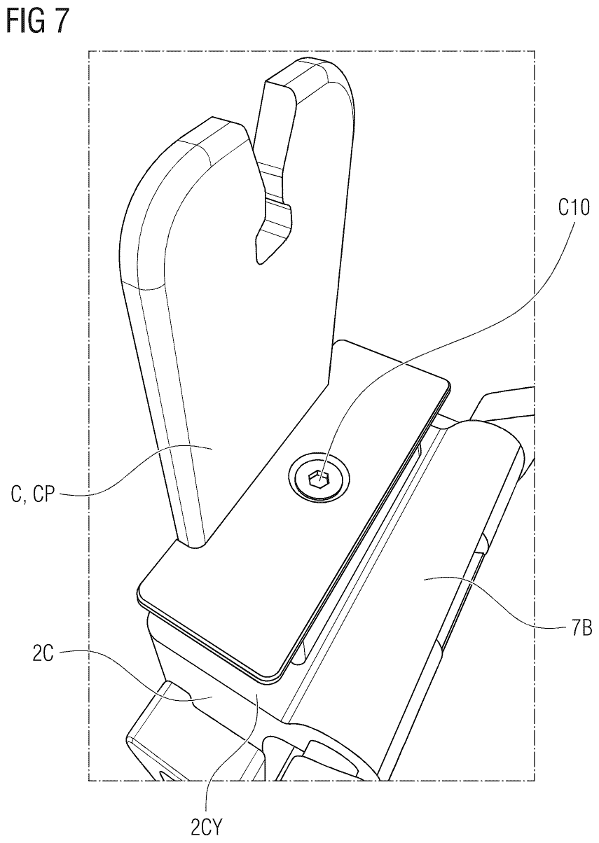

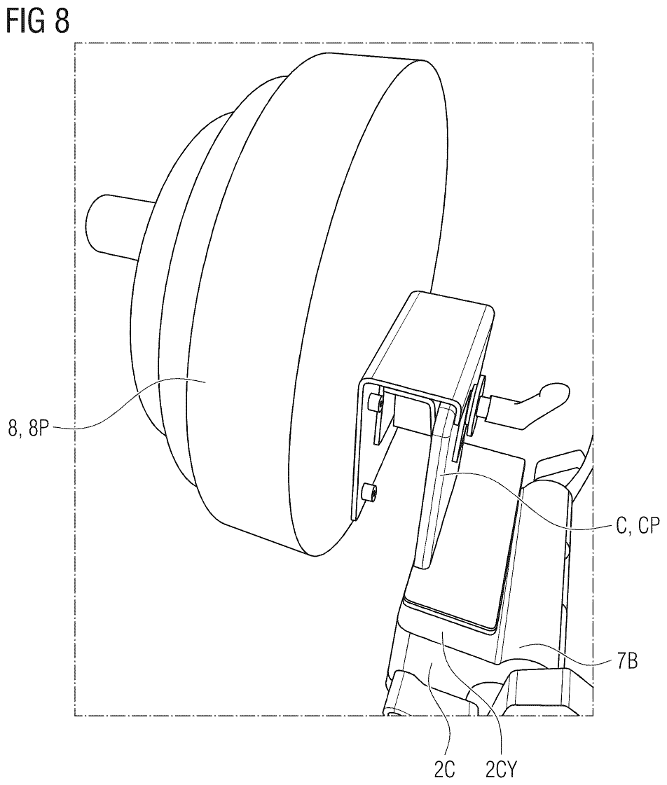

FIG. 7 shows a component-side interface C in the form of the phantom holder CP. FIG. 8 shows the examination phantom 8P. The example shown in FIG. 8 provides that the component 8 has an examination phantom 8P for insertion into the opening 9 for an imaging examination of the examination phantom 8P by way of the computed tomography device 1. The example shown in FIG. 8 provides that the component 8 includes the phantom holder CP. The phantom holder CP is connected to the pin C1 of the component 8 by way of the screw connection C10.

The example shown in FIG. 9 provides that the component 8 has a positioning structure 8L for positioning an object under examination for a pediatric computed tomography examination and has a support surface for the object under examination,
wherein the support surface extends two-dimensionally along a longitudinal axis of the positioning structure 8L,
wherein the first connection axis CA1 is substantially perpendicular to the support surface.

In particular, it can be provided that the longitudinal axis of the positioning structure is parallel to the system axis SA when the component 8 is advanced from above along the first connection axis CA1 until the component 8 is in interlocking connection with the component support surface 2CY on the holding structure 2C.

FIG. 9 shows the computed tomography device 1 in the form of a mobile computed tomography device with the positioning structure 8L for positioning an object under examination for a pediatric computed tomography examination. The object under examination can in particular be a human. The object under examination can for example be a baby or infant. The object under examination can for example be positioned recumbent and/or relative to a gantry of a computed tomography device. The computed tomography device can in particular be configured as a head computed tomography device for the head of an adult human and/or as a mobile computed tomography device.

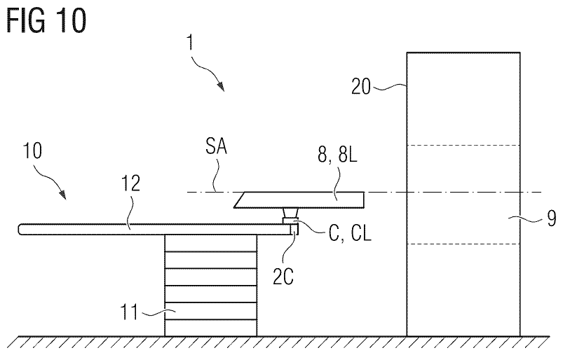

FIG. 10 shows the computed tomography device 1 with the examination table 10, wherein the examination table 10 has the holding structure 2C. For example, the examination table 10 can have a base 11 and a positioning plate 12, wherein the positioning plate 12 is set up for recumbent positioning of a human, in particular an adult human, and, relative to the base 11, is mounted displaceably parallel to the system axis SA of the gantry 20.

In particular, it can be provided that the first device-side interface 1C is fastened to the positioning plate 12 such that, on displacement of the positioning plate 12 relative to the base 11, the holding structure 2C is stationary relative to the positioning plate 12 and/or that, by displacement of the positioning plate 12 relative to the base 11, the component 8 can be inserted into the opening 9 when the component 8 is fixed in place relative to the positioning plate 12 by way of the holding structure 2C and the component-side interface C in the form of the positioning-side interface CL.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of the embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing embodiments. The present invention may, however, be embodied in many alternate forms and should not be construed as limited to only the embodiments set forth herein.

What is claimed is:

1. A computed tomography device, comprising:
a gantry with an opening; and
a holding structure configured to hold a component relative to the opening, the holding structure including
a component support surface that positively counteracts lowering of the component relative to the holding structure along a first connection axis once the component has been advanced from above along the first connection axis to establish a form-fit connection between the component and the component support surface, and
an orientation structure that positively counteracts twisting of the component relative to the holding structure about the first connection axis once the component has been advanced from above along the first connection axis to establish a form-fit connection between the component and the component support surface.

2. The computed tomography device as claimed in claim 1, wherein, in relation to the first connection axis, the orientation structure is below the component support surface.

3. The computed tomography device as claimed in claim 1, wherein the holding structure has a hole to accommodate a pin of the component such that
the pin is inserted into the hole along the first connection axis once the component has been advanced from above along the first connection axis to establish a form-fit connection between the component and the component support surface, and
the component is secured against displacement, perpendicular to the first connection axis, relative to the holding structure by a displacement-blocking connection of the pin with an inner wall of the hole once the pin is inserted into the hole along the first connection axis.

4. The computed tomography device as claimed in claim 3, wherein the inner wall of the hole forms the orientation structure such that the component is secured against twisting of the component relative to the holding structure about the first connection axis by a twist-blocking connection of the pin with the inner wall of the hole once the pin is inserted into the hole along the first connection axis.

5. The computed tomography device as claimed in claim 3, wherein
the hole has a funnel-shaped entry region,
a wide end of the funnel-shaped entry region adjoins the component support surface, and
a narrow end of the funnel-shaped entry region adjoins the inner wall of the hole.

6. The computed tomography device as claimed in claim 3, wherein
the holding structure has a spring pressure piece, and
the spring pressure piece protrudes into the hole through a bore in the inner wall of the hole such that, on insertion of the pin into the hole along the first connection axis, the pin presses away a spring-mounted body of the spring pressure piece against a spring force of the spring pressure piece in a direction that is substantially perpendicular to the first connection axis.

7. The computed tomography device as claimed in claim 1, wherein the first connection axis is vertical.

8. The computed tomography device as claimed in claim 1, wherein the opening extends in a tunnel manner along a system axis of the gantry such that the component is inserted into the opening along the system axis once the component is advanced from above along the first connection axis to establish the form-fit connection between the component and the component support surface.

9. The computed tomography device as claimed in claim 1, wherein
the gantry has a first gantry part and a second gantry part,
the first gantry part has a projection data acquisition system,
the second gantry part has the holding structure,
the first gantry part is mounted movably relative to the second gantry part such that a translational movement of the first gantry part relative to the second gantry part is parallel to a system axis while the component is simultaneously stationary relative to the second gantry part, and
the component is advanced from above along the first connection axis to establish the form-fit connection between the component and the component support surface.

10. The computed tomography device as claimed in claim 1, wherein the computed tomography device includes the component.

11. The computed tomography device as claimed in claim 1, wherein the component has a head shell to hold a human head relative to the opening for an imaging examination of the human head by way of the computed tomography device.

12. The computed tomography device as claimed in claim 1, wherein the component has an examination phantom for insertion into the opening for an imaging examination of the examination phantom by way of the computed tomography device.

13. The computed tomography device as claimed in claim 1, wherein
the component has a positioning structure for positioning an object under examination for a pediatric computed tomography examination and has a support surface for the object under examination,
the support surface extends two-dimensionally along a longitudinal axis of the positioning structure, and
the first connection axis is substantially perpendicular to the support surface.

14. A computed tomography device, comprising:
a gantry with an opening; and
a body support apparatus configured to support a human body relative to the opening, the body support apparatus including a board, a pivot bearing bushing and a pivot bearing pin, wherein
the pivot bearing bushing has a pivot bearing base,
the pivot bearing base extends lengthwise along a pivot axis of the pivot bearing bushing,
the pivot bearing base has a slot that extends parallel to the pivot axis such that the pivot bearing pin is insertable into the slot in an insertion direction that is perpendicular to the pivot axis and perpendicular to a longitudinal direction of the pivot bearing pin,
the pivot bearing bushing has at least one pivot bearing cover,
the pivot bearing pin is secured, by a form-fit connection between the pivot bearing pin and the at least one pivot bearing cover, against displacement relative to the pivot axis in a direction that is opposed to the insertion direction when the pivot bearing pin is arranged substantially coaxially with the pivot axis and the at least one pivot bearing cover is connected to the pivot bearing base, and
the board is configured to be mounted such that the board pivots relative to the gantry about the pivot axis by way of the pivot bearing bushing and the pivot bearing pin such that the board is lowerable relative to the gantry from a preparation position of the board to an examination position of the board by a first pivot movement of the board about the pivot axis.

15. The computed tomography device as claimed in claim 14, wherein
the pivot bearing base has a groove that extends parallel to the pivot axis such that the at least one pivot bearing cover is insertable into the slot in a direction parallel to the pivot axis, and
a rib of the at least one pivot bearing cover is insertable into the groove in the direction parallel to the pivot axis such that the at least one pivot bearing cover is secured against displacement relative to the pivot axis in at least one of the insertion direction or a direction that is opposed to the insertion direction by a form-fit connection between the rib and the groove.

16. The computed tomography device as claimed in claim 6, wherein the pin presses away the spring-mounted body of the spring pressure piece against the spring force of the spring pressure piece in the direction that is substantially perpendicular to the first connection axis before achieving the form-fit connection between the component and the component support surface.

17. The computed tomography device of claim 14, wherein the pivot bearing pin is insertable into the slot in the insertion direction that is perpendicular to the pivot axis and perpendicular to the longitudinal direction of the pivot bearing pin until the pivot bearing pin is arranged substantially coaxially with the pivot axis.

18. The computed tomography device as claimed in claim 4, wherein
the hole has a funnel-shaped entry region,
a wide end of the funnel-shaped entry region adjoins the component support surface, and
a narrow end of the funnel-shaped entry region adjoins the inner wall of the hole.

19. The computed tomography device as claimed in claim 4, wherein
the holding structure has a spring pressure piece, and
the spring pressure piece protrudes into the hole through a bore in the inner wall of the hole such that, on insertion of the pin into the hole along the first connection axis, the pin presses away a spring-mounted body of the spring pressure piece against a spring force of the spring pressure piece in a direction that is substantially perpendicular to the first connection axis.

20. The computed tomography device as claimed in claim 4, wherein the opening extends in a tunnel manner along a system axis of the gantry such that the component is inserted into the opening along the system axis once the component is advanced from above along the first connection axis to establish the form-fit connection between the component and the component support surface.
